(19) United States
(12) Patent Application Publication
(10) Pub. No.: US 2003/0035695 A1
(43) Pub. Date: Feb. 20, 2003

(54) Portable decking system for use in standard van trailers

(76) Inventor: David Blackmon, Evans, GA (US)

Correspondence Address: NEXSEN PRUET JACOBS & POLLARD, LLC, P.O. Box 10107, Greenville, SC, 29603, US

(21) Appl. No.: 10/223,924

(22) Filed: Aug. 19, 2002

Related U.S. Application Data
(60) Provisional application No. 60/313,191, filed on Aug. 17, 2001.

(51) Int. Cl. B60P 3/08

(52) U.S. Cl. 410/26

(57) ABSTRACT

A portable decking system for use in conventional van trailers. The decking system includes at least one load bar connected between logistic posts on opposite side-walls of the trailer, at least one deck plate that is pivotably attachable and securable to a load bar using brackets, a lifting device connected to an end of the trailer for vertically displacing an end of a deck plate, and at least one support bar attached to the underside of a deck plate to secure the deck plate for transportation. Each of the components of the portable decking system are removable to allow for portability, storage, and ease of installation into van trailers.

### REFERENCE OF RELATED APPLICATION

This application claims the benefit of U.S. Provisional Application No. 60/313,191, filed Aug. 17, 2001.

### FIELD OF THE INVENTION

This invention relates to a portable decking for use in standard van trailers.

### BACKGROUND OF THE INVENTION

Ground transportation of cargo via trailers is a widely used form of shipment to deliver cargo across great distances. In view of increasing fuel costs and a continuing need to curb costs associated with ground transportation, and thus maintain or increase profit, maximizing the amount of cargo that a trailer is capable of transporting becomes an important business consideration. An efficient use of trailer space is particularly significant when transporting cargo of smaller individual scale. For example, when smaller vehicles are loaded onto a trailer in a single tier or level configuration, a substantial amount of space remains above the vehicles that may otherwise be used for transporting additional cargo. In an attempt to address this shipment inefficiency, a two-tier system has been utilized in trailers.

Presently, the only known means of decking, transporting and ground-delivering two tiers of small vehicles, such as golf cars, riding lawn mowers, all-terrain vehicles (ATV's), etc., is with utilization of specially designed and built golf car trailers which have an internal decking system integrated and permanently affixed inside the trailer cavity. These trailers are expensive, require extensive lead time for order and delivery, and possess compromised payload and internal-height clearance factors due to the permanently affixed deck-lifting systems.

What is therefore needed is a decking system that can be simply integrated with existing trailers to load and unload cargo from the trailer. More particularly, what is needed is a removable and portable decking system that can be used with existing trailers to load and unload cargo and provide a secure platform for the loaded cargo during transport.

### SUMMARY OF THE INVENTION

An object of the present invention is to provide a decking system that can be simply integrated with existing trailers to load and unload cargo from the trailer.

A more particular object of the present invention is to provide a removable and portable decking system that can be used with existing trailers to load and unload cargo and provide a secure platform for the loaded cargo during transport.

Another object of the present invention is to provide a decking system having a pivoting ramp that allows for loading of cargo into the trailer with multiple tiers of cargo.

Another, more particular object of the present invention is to provide a decking system having a pivoting ramp that allows for loading of cargo onto and off of a second tier in the trailer and that is securable in a horizontal position for transportation of the cargo.

These and other objects of the invention are accomplished by providing a portable decking and ground delivery system that can be easily installed in standard van trailers, utilizing existing e-track wall supports common to many over the road trailers and used as the receiving device. The system is portable from one trailer to another. In a preferred embodiment, the invented portable decking system includes at least one load bar that removably interconnects posts of a pair of side-walls of a conventional trailer, at least one deck plate having a pair of opposing ends that is rotatably attachable to the load bar, at least one bracket that is attached to one end of the deck plate, a raising/lowering mechanism that is coupled with the other end of the deck plate, and at least one support bar that is removably attachable to an underside of the deck plate and at least one of the side-walls of the trailer.

### BRIEF DESCRIPTION OF THE DRAWINGS

FIG. 1 is a perspective view of a portable decking system in accordance with one embodiment of the present invention illustrated with a cutaway view of a trailer.

FIG. 2A is a rear view of the portable decking system shown in FIG. 1.

FIG. 2B is a sectional view of the portable decking system shown in FIG. 2A taken along lines X-X.

FIG. 3 is a perspective view of a portable decking system in accordance with one embodiment of the present invention showing deck plates in a transportation configuration.

FIG. 4A a rear view of the portable decking system shown in FIG. 3.

FIG. 4B is a sectional view of the portable decking system shown in FIG. 4A taken along lines Y-Y.

### DETAILED DESCRIPTION OF THE INVENTION

The present invention is a portable decking system for use with conventional ground transportation trailers that is easily installed in the trailers and utilizes existing wall supports found in the trailers to establish a moveable ramp. The portable decking system is easily integrated into the trailer and removable from the trailer allowing portability from one trailer to another. The present invention also provides a decking system having a pivoting ramp that allows for loading of cargo into a trailer with multiple tiers of cargo. The pivoting ramp is securable in a horizontal position for transportation of the cargo.

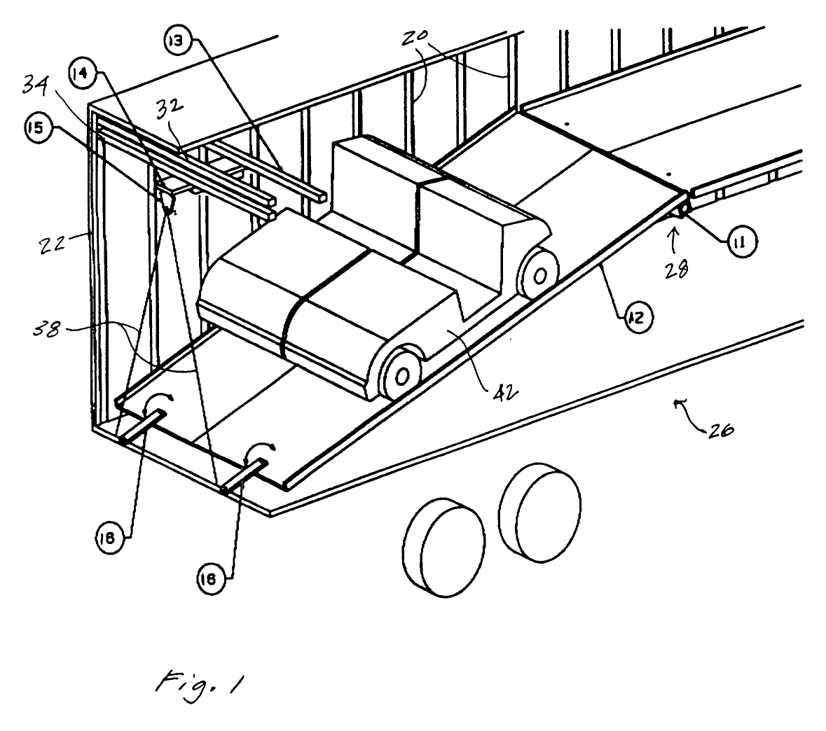

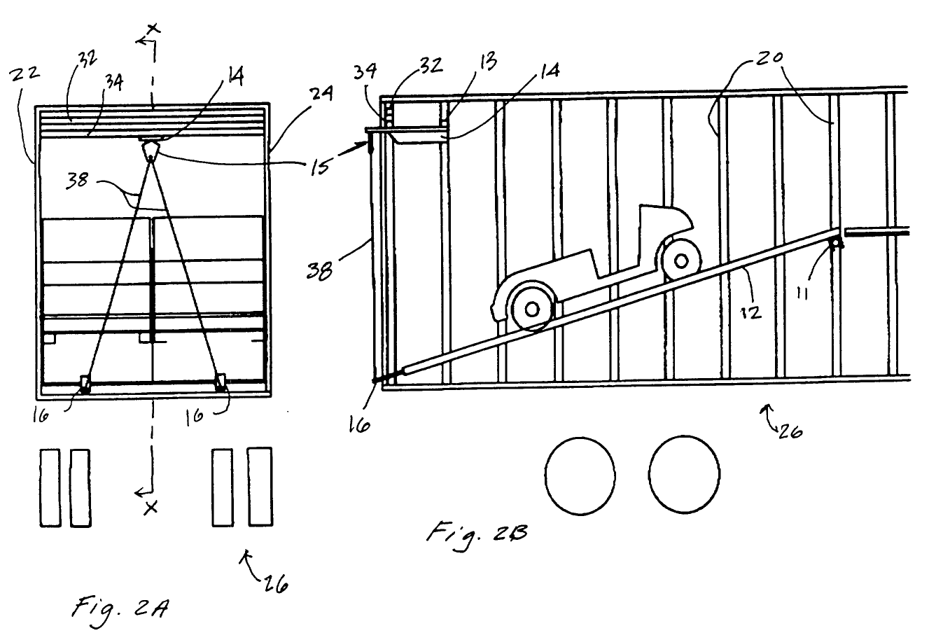

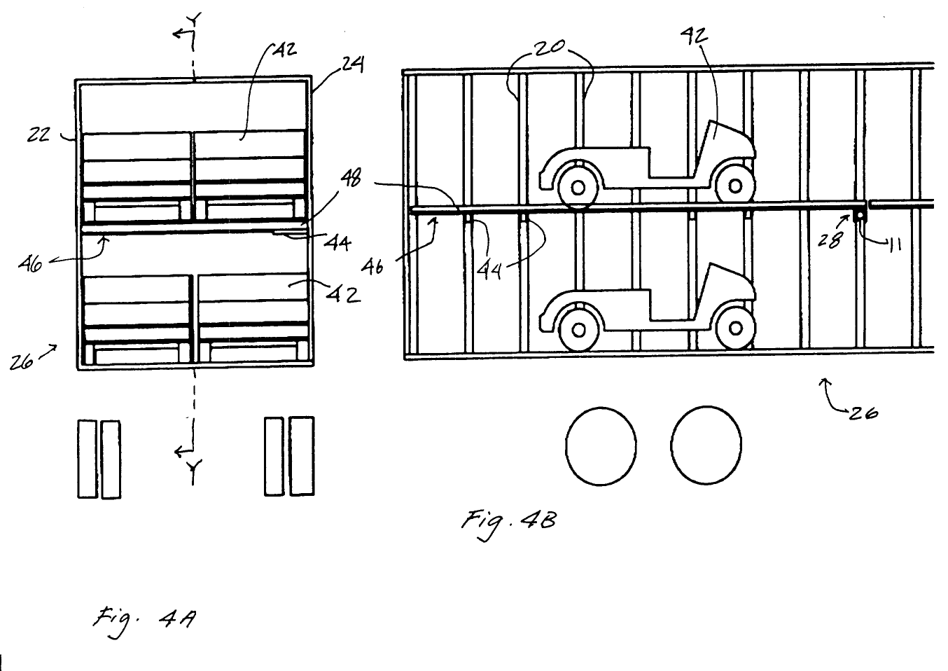

Referring now to the drawings, FIG. 1 is a perspective view of a portable decking system in accordance with one embodiment of the present invention illustrated with a cutaway view of a trailer, shown generally at 26. FIG. 2A is a rear view of the portable decking system shown in FIG. 1. FIG. 2B is a sectional view of the portable decking system shown in FIG. 2A taken along lines X-X. The trailer 26 is shown for convenience of establishing integration of the decking system. However, the invented decking system may be integrated with alternative conventional trailer configurations using a variety of trailer side-wall support mechanisms. In this embodiment, the trailer 26 includes a pair of opposing side-walls 22, 24 (FIGS. 2A and 4A) where each of the side-walls 22, 24 has at least one post 20 for ribbing support of the side-wall 22, 24.

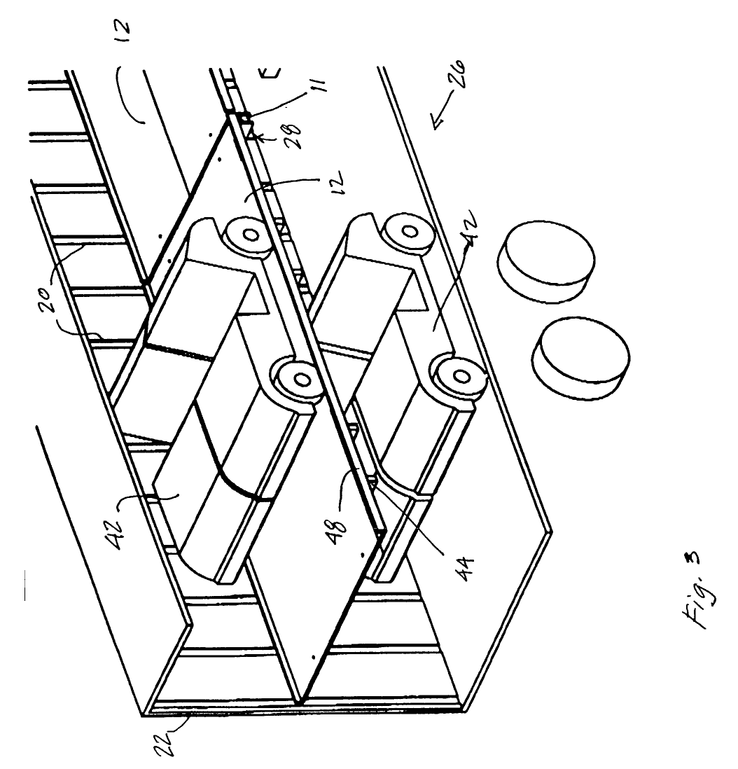

The decking system includes at least one load bar 11 that removably interconnects the post 20 of one side-wall 22 with the post of the other opposing side-wall 24, at least one deck plate 12 that is rotatably attachable to the load bar 11, at least one bracket, shown generally at 28, that is attached to one end of the deck plate 12 and coupled with the load bar 11, and at least one support bar 44 (FIGS. 3, 4A, and 4B) that is removably attachable to the deck plate 12 and at least one of the side-walls 22, 24. The deck plate 12 has an underside, shown generally at 46 (FIGS. 4A and 4B) such that the support bar 44 is attachable thereto. The decking system also includes a deck-lifting subsystem that pivots the deck plate 12 about the load bar 11 as described in greater detail below.

The load bar 11 is temporarily attached to both side-walls 22, 24 of the trailer 26, and is preferably temporarily anchored to the posts 20 of the side-walls 22, 24 to prevent shifting of the load bar 11 during loading and unloading of cargo and transportation of the same. Any suitable high strength material, such as metal alloy or composite polymer material, may be used to form the load bar 11. When installed, the load bar 11 is preferably horizontally aligned between the side-walls 22, 24. The deck plate 12 may be constructed using collapsible or removable grids and has the bracket 28 affixed to one end of the deck plate 12. The bracket 28 is preferably U-shaped, although alternative conventional brackets may be used that allow a freedom of movement by the deck plate 12 about the load bar 11. The resulting combination of the deck plate 12 with the attached bracket 28 coupled with the load bar 11 forms a moveable ramp 48 that pivots about the load bar 11.

In a preferred embodiment of the present invention, the aforementioned subsystem that pivots the deck plate 12 is coupled with the end of the deck plate 12 that is opposite the end of the deck plate 12 that is attachable to the load bar 11. In this embodiment, the deck-lifting subsystem includes a load supporting structure 13, 14, 32, 34 that is removably attached to a top and rear portion of the trailer 26 and a raising/lowering mechanism 15, 38 that is attachable to the load supporting structure 13, 14, 32, 34 and removably coupled to one end of the deck plate 26.

In one embodiment, as best shown in FIG. 1, the load supporting structure includes structure bars 13, 32, 34 that are positioned at the top rear portion of the trailer 26 and interconnect the side-walls 22, 24 of the trailer 26 and a platform 14 that is connected across at least two of the structure bars 13, 34. The raising/lowering mechanism 15, 38 is selected from a hoist, a pneumatic lift, a hydraulic lift, and a manual-crank lift. In a hoist configuration, as best shown in FIGS. 1, 2A, and 2B, the hoist 15 is connected to the end of the deck plate 12 by a chain 38, rope, or other conventional variable length connection.

Although the deck-lifting subsystem is described in relation to lifting one end of the deck plate 12 that is opposite the end of the deck plate coupled to the load bar 11, the deck-lifting subsystem may include a lift mechanism that is attachable to the end of the deck plate 12 that is coupled to the load bar 11. For example, a hydraulic lift or pneumatic lift may be coupled to adjacent deck plates 12 to pivot one deck plate about the load bar 11.

FIG. 3 is a perspective view of a portable decking system in accordance with one embodiment of the present invention showing deck plates 12 in a transportation configuration. FIG. 4A a rear view of the portable decking system shown in FIG. 3. FIG. 4B is a sectional view of the portable decking system shown in FIG. 4A taken along lines Y-Y. When the trailer is loaded for transportation, the support bars 44 are removably attached to the underside 46 of the deck plate and to at least one of the side-walls 22, 24 of the trailer 26. The support bars 44 are temporarily affixed to at least one of the side-walls 22, 24 to prevent shifting of the ramp 48 or deck plate 12. Any high strength material, such as metal alloy and composite polymer material, may be used to form the support bars 44.

As best shown in FIGS. 3, 4A, and 4B, when the trailer is fully loaded, the ramps 48 are raised to a horizontal position using the deck-lifting subsystem and secured for transportation using the support bars 44. When the ramps 48 are secured, the deck-lifting subsystem is dismounted and stowed away. The deck-lifting subsystem is then re-mounted for lowering the ramps 48 to allow unloading of the cargo.

Those of ordinary skill in the art will be aware of other variations that are within the scope of the claimed invention, which is to be measured by the following claims.

What is claimed is:

1. A portable decking system for trailers having a pair of opposing side-walls, each of the pair of side-walls having at least one post for ribbing support of the side-wall, said system comprising:
at least one load bar removably interconnecting posts of the pair of side-walls;
at least one deck plate rotatably attachable to said at least one load bar, said at least one deck plate having a pair of opposing ends and an underside;
at least one bracket fixedly attached to a first end of said pair of opposing ends of said at least one deck plate and coupled with said at least one load bar;
means for pivoting said at least one deck plate coupled with a second end of said pair of opposing ends of said at least one deck plate; and
at least one support bar removably attachable to said underside of said at least one deck plate and at least one of the side-walls.

2. A portable decking system according to claim 1, wherein said pivoting means comprises:
a load supporting structure removably attached to a top of the trailer at a rear of the trailer; and
means for raising/lowering said second end of said at least one deck plate attachable to said load supporting structure and removably coupled to said second end of said at least one deck plate.

3. A portable decking system according to claim 2, wherein said load supporting structure comprises:
at least two structure bars positioned at a rear of the trailer and interconnecting the side-walls of the trailer; and
a platform connected across said at least two structure bars.

4. A portable decking system according to claim 3, wherein said raising/lowering means is selected from a hoist, a pneumatic lift, a hydraulic lift, and a manual-crank lift.

5. A portable decking system according to claim 1, wherein said at least one load bar is substantially horizontally positioned between the side-walls.

6. A portable decking system according to claim 1, wherein said pivoting means is selected from a hoist, a pneumatic lift, a hydraulic lift, and a manual-crank lift.

7. A portable decking system for use with trailers having a pair of opposing side-walls, each of the pair of side-walls having at least one post for ribbing support of the wall, said system comprising:
a load-bearing support means horizontally positioned between the side-walls of the trailer;
at least one deck plate having a pair of opposing ends, said at least one deck plate rotatably connectable to said load-bearing support means;
means for removably coupling said at least one deck plate to said load-bearing support means, said coupling means attached to a first end of said at least one deck plate;
means for raising/lowering a second end of said at least one deck plate removably attachable to the trailer; and
means for removably securing said at least one deck plate.

8. A portable decking system according to claim 7, wherein said load-bearing support means comprises at least one load bar removably interconnecting the side-walls of the trailer.

9. A portable decking system according to claim 8, wherein said coupling means is a U-shaped bracket, said bracket receiving one of said at least one load bar.

10. A portable decking system according to claim 7 further comprising a support connected to the trailer interconnecting said raising/lowering means and the trailer.

11. A portable decking system according to claim 10, wherein said raising/lowering means is selected from a hoist, a pneumatic lift, a hydraulic lift, and a manual-crank lift.

12. A portable decking system according to claim 11, wherein said support comprises:
at least one support bar interconnecting the side-walls of the trailer; and
a platform attached to said at least on support bar;
wherein said raising/lowering means is coupled to said platform.
